(19) United States
(12) Patent Application Publication
(10) Pub. No.: US 2010/0227251 A1
(43) Pub. Date: Sep. 9, 2010

(54) CATALYST LAYER, MEMBRANE ELECTRODE ASSEMBLY, FUEL CELL, AND METHOD OF PRODUCING THE CATALYST LAYER

(75) Inventor: Hiroshi Okura, Hiratsuka-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/681,653

(22) PCT Filed: Dec. 3, 2008
(86) PCT No.: PCT/JP2008/072357

§ 371 Date: Apr. 5, 2010

(30) Foreign Application Priority Data
Dec. 10, 2007 (JP) 2007-318481

(51) Int. Cl. H01M 8/10; H01M 4/92; H01M 4/88

(52) U.S. Cl. 429/483; 429/487; 502/101

(57) ABSTRACT

Provided are a highly active catalyst layer including platinum and a metal other than platinum, a membrane electrode assembly, a fuel cell, and a method of producing the catalyst layer. A catalyst layer for a fuel cell includes a polymer electrolyte, and a catalyst structure having a dendritic shape, in which the catalyst structure having the dendritic shape includes platinum and a metal other than platinum, and in which a platinum compositional ratio of a surface of the catalyst structure having the dendritic shape is higher than a platinum compositional ratio of the whole of the catalyst structure having the dendritic shape.

### TECHNICAL FIELD

The present invention relates to a catalyst layer, a membrane electrode assembly, a fuel cell, and a method of producing the catalyst layer.

### BACKGROUND ART

In recent years, a fuel cell has been required to have a higher power density. As for a catalyst, a catalyst material having a higher activity is being required. As an example of the catalyst material, a catalyst layer that employs fine particles including platinum and a metal other than platinum has attracted attention. As one example of such a catalyst layer, Japanese Patent Application Laid-Open No. 2005-135900 discloses fine particles each having an inner part which is in an alloy state and a surface layer including platinum.

### DISCLOSURE OF THE INVENTION

However, the method described in Japanese Patent Application Laid-Open No. 2005-135900 includes heat treatment of fine particles for preventing a nonmetal part from dissoluting because of being brought into contact with an electrolyte. There is a problem that treatment of the fine particles at high temperatures causes aggregation of the fine particles into huge particles, resulting in reduction of the specific surface area of the catalyst and lowering of the catalytic activity. Therefore, there has been a great need to develop a highly active catalytic layer including platinum and a metal other than platinum.

The present invention has been accomplished in view of the background art described above, and provides a highly active catalyst including platinum and a metal other than platinum. Thereby, the present invention provides a stable, high power catalyst layer, a membrane electrode assembly, a fuel cell, and a method of producing the catalyst layer.

The present invention provides a catalyst layer which includes a polymer electrolyte and a catalyst structure having a dendritic shape, in which the catalyst structure having the dendritic shape includes platinum and a metal other than platinum, and in which a platinum compositional ratio of a surface of the catalyst structure having the dendritic shape is higher than a platinum compositional ratio of the whole of the catalyst structure having the dendritic shape.

The present invention further provides a method of producing a catalyst layer, which includes:

forming a first catalyst precursor layer including platinum, a metal other than platinum and oxygen and having a dendritic shape;

reducing the first catalyst precursor layer to obtain a second catalyst precursor layer;

substituting at least a part of the metal other than platinum existing in a surface of the second catalyst precursor layer with platinum to obtain a layer including a catalyst structure; and

applying a polymer electrolyte to a surface of the catalyst structure to obtain a catalyst layer.

The present invention further provides a method of producing a catalyst layer, which includes:

forming a first catalyst precursor layer including platinum, a metal other than platinum, and oxygen and having a dendritic shape;

applying a polymer electrolyte to a surface of the first catalyst precursor layer;

reducing the first catalyst precursor layer to obtain a second catalyst precursor layer; and

substituting at least a part of the metal other than platinum existing in a surface of the second catalyst precursor layer with platinum to obtain a catalyst layer.

The present invention further provides a catalyst layer for a fuel cell which includes a polymer electrolyte and a catalyst structure having a dendritic shape, in which the catalyst structure having the dendritic shape includes platinum and a metal other than platinum, and in which a platinum compositional ratio of a surface of the catalyst structure having the dendritic shape is higher than a platinum compositional ratio of the whole of the catalyst structure having the dendritic shape.

In the present invention, the metal other than platinum may be cobalt.

The present invention further provides a membrane electrode assembly including the catalyst layer for a fuel cell. The present invention further provides a fuel cell including the catalyst layer for a fuel cell.

The present invention further provides a method of producing a catalyst layer for a fuel cell, which includes:

forming a first catalyst precursor layer including platinum, a metal other than platinum and oxygen and having a dendritic shape;

reducing the first catalyst precursor layer to obtain a second catalyst precursor layer;

substituting at least a part of the metal other than platinum existing in a surface of the second catalyst precursor layer with platinum to obtain a layer including a catalyst structure; and

applying a polymer electrolyte to a surface of the catalyst structure to obtain a catalyst layer.

The present invention further provides a method of producing a catalyst layer for a fuel cell, which includes:

forming a first catalyst precursor layer including platinum, a metal other than platinum, and oxygen and having a dendritic shape;

applying a polymer electrolyte to a surface of the first catalyst precursor layer;

reducing the first catalyst precursor layer to obtain a second catalyst precursor layer; and

substituting at least a part of the metal other than platinum existing in a surface of the second catalyst precursor layer with platinum to obtain a catalyst layer.

According to the present invention, there may be provided a highly active catalyst layer including platinum and a metal other than platinum, a membrane electrode assembly, a fuel cell, and a method of producing the catalyst layer.

Further features of the present invention will become apparent from the following description of exemplary embodiments with reference to the attached drawings.

### BRIEF DESCRIPTION OF THE DRAWINGS

FIGS. 1A and 1B are schematic views illustrating an example of a structure of a membrane electrode assembly in accordance with the present invention.

FIGS. 2A, 2B, and 2C are structural views illustrating an example of a catalyst structure having a dendritic shape.

FIG. 3 is a graph illustrating measured results of current-voltage characteristics of Example 1 and Comparative Example 1.

FIG. 4 is a graph illustrating measured results of activation resistance of Example 1 and Comparative Example 1.

FIG. 5 is a general schematic view illustrating a fuel cell.

FIG. 6 is a graph illustrating measured results of current-voltage characteristics of Example 2 and Comparative Example 2.

FIG. 7 is a graph illustrating measured results of activation resistance of Example 2 and Comparative Example 2.

### BEST MODE FOR CARRYING OUT THE INVENTION

Hereinafter, embodiments of the present invention are described with reference to the accompanying drawings.

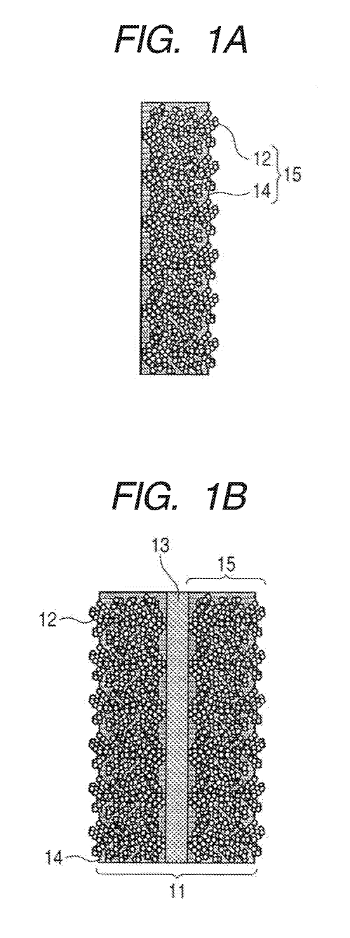

FIG. 1A schematically illustrates an example of a catalyst layer in accordance with the present invention, and FIG. 1B schematically illustrates an example of a membrane electrode assembly employing the catalyst layer in accordance with the present invention.

FIG. 1A illustrates a catalyst structure 12 having a dendritic shape, a polymer electrolyte 14, and a catalyst layer 15. FIG. 1B illustrates a polymer electrolyte membrane 13 and a membrane electrode assembly 11. Incidentally, like elements in the respective figures have similar reference numbers.

The catalyst layer 15 includes the catalyst structure 12 having a dendritic shape and the polymer electrolyte 14 present on a surface of the catalyst structure.

Hereinafter, respective parts constituting the catalyst layer 15 are described.

The catalyst structure 12 having the dendritic shape includes platinum and a metal other than platinum. The catalyst structure having the dendritic shape may include platinum and several kinds of metals other than platinum, or platinum and one kind of metal other than platinum. As the metal other than platinum, a metal which is capable of improving the catalytic activity of platinum may preferably be used. In the case where the catalyst structure includes platinum and several kinds of metals other than platinum, the several kinds of metals other than platinum may include at least one metal which is capable of improving the catalytic activity of platinum and at least one metal which has no such function. As the metal other than platinum, for example, cobalt, copper, iron, nickel, palladium, and iridium may be used. Of those, cobalt, copper, iron, and nickel are preferred because of their high functions of improving the catalytic activity of platinum, and cobalt is more preferred. In other words, at least one kind of metals other than platinum having a dendritic shape is preferably cobalt.

Incidentally, the term “dendritic structure” herein employed refers to a structure in which a flake-shaped (flaky) substructures constituted by aggregation of catalyst particles are gathered in a large number while having branch points. It is preferred that the length in lateral direction of one of the flaky substructures is 5 nm or more and 200 nm or less. Incidentally, the term “length in lateral direction” herein employed refers to a smallest dimension within a plane of one flake.

Furthermore, the platinum compositional ratio in a surface of the catalyst structure 12 having the dendritic shape is higher than the platinum compositional ratio of the whole of the catalyst structure having the dendritic shape.

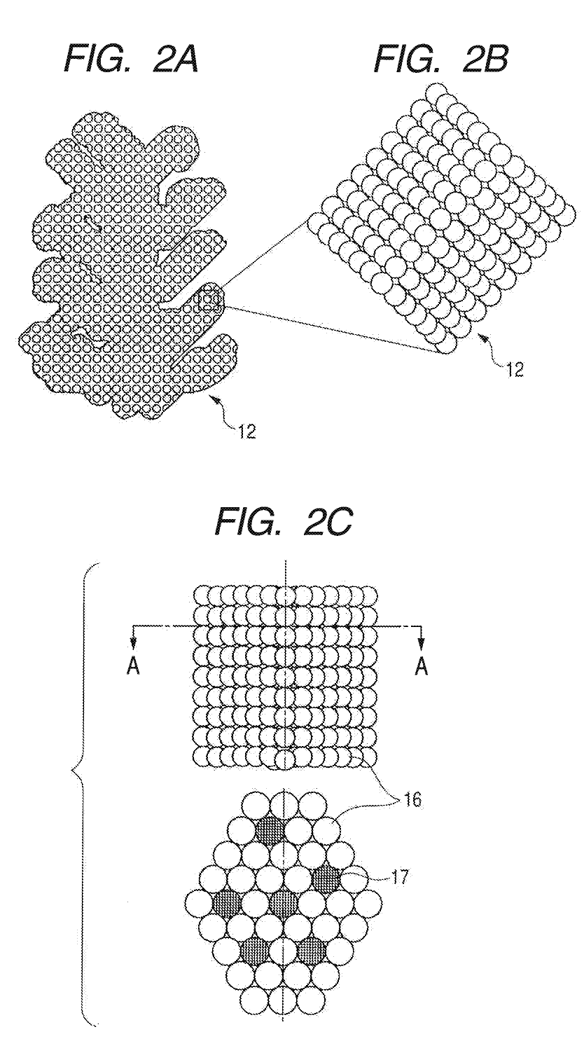

This feature is described with reference to FIGS. 2A, 2B, and 2C. FIG. 2A is a schematic view of a part of a catalyst structure having a dendritic shape, and FIG. 2B is an enlarged view of a part of a site having the dendritic shape. The lower part of FIG. 2C is a schematic sectional view of the dendritic shape such as illustrated in the enlarged manner in FIG. 2B, taken along the line A-A at the upper part of FIG. 2C. As illustrated in FIG. 2C, the catalyst structure having the dendritic shape includes platinum fine particles 16 and fine particles 17 formed of the metal other than platinum.

As illustrated in FIG. 2C, the embodiment of the catalyst structure having the dendritic shape in accordance with the present invention has a higher ratio of the platinum fine particles 16 on a surface than in an inner part. In the inner part of the catalyst structure having the dendritic shape, fine particles of the metal other than platinum account for a substantial ratio. On the other hand, in the surface thereof, the platinum fine particles 16 account for a large part. Thus, the embodiment of the catalyst structure having the dendritic shape in accordance with the present invention has different platinum compositional ratios in the surface part and in the inner part, and the platinum compositional ratio in the surface is higher than the platinum compositional ratio in the inner part. In other words, the platinum compositional ratio in the surface of the catalyst structure is higher than the platinum compositional ratio of the whole of the catalyst structure.

Incidentally, for calculation of the platinum compositional ratio at the surface of the catalyst structure having the dendritic shape, Electron Spectroscopy for Chemical Analysis (ESCA) may be used, for example. Furthermore, for calculation of the platinum compositional ratio of the whole of the catalyst structure having the dendritic shape, Energy Dispersive X-ray Spectroscopy (EDX) may be used, for example.

Here, the term “surface of a catalyst structure having a dendritic shape” herein employed refers to a part of a dendritic catalyst which is to be in contact with a fuel or a polymer electrolyte.

The composition is determined by using the two analysis methods. In the case where the platinum compositional ratio determined by ESCA is higher than the platinum compositional ratio determined by EDX, it is determined that the platinum compositional ratio in the surface of the catalyst structure is higher than the compositional ratio of the whole of the catalyst structure.

Incidentally, although in FIGS. 2A to 2C the platinum fine particles 16 and the fine particles 17 including the metal other than platinum which are particles constituting the catalyst structure 12 having the dendritic shape are represented by spheres for convenience of presentation, the shapes are not limited to spheres. The catalyst structure 12 may be a structure in which platinum and metal(s) other than platinum are crystallized, a structure in which platinum and metal(s) other than platinum are randomly aggregated, and the like. The shapes of microstructures that constitute these structures may be any of spheres, needles, cylinders, and quadratic prisms.

Next, the membrane electrode assembly is described.

The membrane electrode assembly illustrated in FIG. 1B includes the polymer electrolyte membrane 13 and the two catalyst layers 15 described above.

The polymer electrolyte membrane 13 has a proton conducting group and has a function of transporting protons generated in the anode side to the cathode side. Specific examples of such a group having proton conductivity include a sulfonic acid group, a sulfinic acid group, a carboxylic acid group, a phosphonic acid group, a phosphinic acid group, a phosphoric acid group, and a hydroxyl group. In addition, examples of the polymer electrolyte membrane include a perfluorocarbon sulfonic acid resin, a polystyrene sulfonic acid resin, a sulfonated polyamide imide resin, a sulfonated polysulfone resin, a sulfonated polyether imide semipermeable membrane, a perfluoro phosphonic acid resin, and a perfluoro sulfonic acid resin.

The catalyst layer in accordance with the present invention may be used as a catalyst layer for a fuel cell or a catalyst layer for purification of vehicle exhaust gas. Furthermore, the membrane electrode assembly in accordance with the present invention may be used as a membrane electrode assembly for a fuel cell.

Next, the methods of producing the catalyst layer, the membrane electrode assembly, and the fuel cell of the present invention is described.

The first method of producing a catalyst layer in accordance with the present invention includes the steps of:

(i) forming a first catalyst precursor layer including platinum, a metal other than platinum and oxygen and having a dendritic shape;

(ii) reducing the first catalyst precursor layer to obtain a second catalyst precursor layer;

(iii) substituting at least a part of the metal other than platinum existing in a surface of the second catalyst precursor layer with platinum to obtain a layer including a catalyst structure; and

(iv) applying a polymer electrolyte to a surface of the catalyst structure to obtain a catalyst layer.

### (As to Step (i))

In the step (i), a first catalyst precursor layer containing at least platinum, metal(s) other than platinum, and oxygen and having a dendritic shape is formed. The process of forming the first catalyst precursor layer is preferably a vapor phase process, and more preferably a vapor phase process involving a reaction of oxygen, platinum, and the metal(s) other than platinum. Examples of such a vapor phase process include, but not limited to, a sputtering process, a resistive heating evaporation, and electron beam evaporation (EB evaporation). Of those, the sputtering process is preferably used.

(As to Step (ii))

In the step (ii), the first catalyst precursor layer is reduced to obtain a second catalyst precursor layer.

Examples of the process of reducing the first catalyst precursor layer include application of a reduction potential, reduction using hydrogen, and reduction using a reducing solution. Of those, the reduction process using hydrogen is preferred.

(As to Step (iii))

In the step (iii), at least a part of the metal(s) other than platinum which exists in a surface of the second catalyst precursor layer obtained in the step (ii) is substituted with platinum to obtain a layer including a catalyst structure.

An example of the process of substituting at least a part of the metal(s) other than platinum present in a surface of the second catalyst precursor layer with platinum is a process of immersing the second catalyst precursor layer in a solution containing platinum ions. As the solution that contains platinum ions, a solution containing a platinum-containing complex as a solute is preferably used. As such a platinum-containing complex, potassium hexachloroplatinate (IV), hydrogen hexachloroplatinate (IV), potassium tetrachloroplatinate (II), and the like may be used.

The concentration of a platinum salt in the solution containing platinum ions is preferably 0.1 mmol/L or more and 50 mmol/L or less, and more preferably 1 mmol/L or more and 10 mmol/L or less. The reason is that when the platinum ion concentration is too low, the substitution of the metal other than platinum with platinum may not be conducted sufficiently, while when the platinum ion concentration is too high, the dendritic shape may be destroyed by immersing the dendritic structure in the solution.

(As to Step (iv))

In the step (iv), a polymer electrolyte is applied to a surface of the layer including the catalyst structure to obtain a catalyst layer.

The polymer electrolyte to be applied to the surface of the layer including the catalyst structure has proton conductivity. An example of the polymer electrolyte having proton conductivity is Nafion (registered trademark). Incidentally, it is preferable that the polymer electrolyte is dissolved in an organic solvent and applied to a layer including the catalyst structure. Examples of the organic solvent include ethanol and isopropyl alcohol. Such an organic solvent may be used alone, or several kinds thereof may be mixed and used as an organic solvent. In the case where Nafion is used as a polymer electrolyte, a solvent containing isopropyl alcohol as a main component is preferably used as an organic solvent. Examples of the process of applying the polymer electrolyte include a dipping process, a spray process, and a dropping process.

By the above described procedure, the catalyst layer having a dendritic shape can be obtained.

Next, a second method of producing a catalyst layer in accordance with the present invention is described.

The second method of producing a catalyst layer includes:

(I) forming a first catalyst precursor layer including platinum, a metal other than platinum, and oxygen and having a dendritic shape;

(II) applying a polymer electrolyte to a surface of the first catalyst precursor layer;

(III) reducing the first catalyst precursor layer to obtain a second catalyst precursor layer; and

(IV) substituting at least a part of the metal other than platinum existing in a surface of the second catalyst precursor layer with platinum to obtain a catalyst layer.

The second method of producing a catalyst layer for a fuel cell differs from the first method of producing a catalyst layer for a fuel cell in the steps (II) to (IV).

In the step (II), a polymer electrolyte is applied to the surface of the first catalyst precursor layer formed in the step (I). The polymer electrolyte to be applied and the application process are the same as those in the step (iv) of the first method of producing a catalyst layer for a fuel cell.

In the step (III), the first catalyst precursor layer is reduced to form the second catalyst precursor layer in the same manner as in the step (ii) of the first method of producing a catalyst layer for a fuel cell. The step (III) differs from the step (iii) of the first method of producing a catalyst layer for a fuel cell in that the first catalyst precursor layer having the polymer electrolyte applied thereto is reduced to form the second catalyst precursor layer.

In the step (IV), the metal other than platinum existing in the surface of the second catalyst precursor layer is substituted with platinum to obtain a layer including a catalyst structure in the same manner as in the step (iii) of the first method of producing a catalyst layer for a fuel cell. The step (IV) differs from the step (iii) of the first method of producing a catalyst layer in that in the step (IV), the metal other than platinum existing in the surface of the second catalyst precursor layer having the polymer electrolyte applied thereto is substituted with platinum. In this way, the catalyst layer having a dendritic shape may be obtained.

Next, a method of producing a membrane electrode assembly is described.

The membrane electrode assembly can be obtained by transferring two catalyst layers produced through the above-mentioned methods to a polymer electrolyte membrane, or can be obtained by forming catalyst layers on a polymer electrolyte membrane. Alternatively, one catalyst layer may be transferred to a polymer electrolyte membrane, and another catalyst layer may be formed directly on the polymer electrolyte membrane.

Incidentally, the transfer may be conducted through hot pressing or the like. The hot pressing temperature at that time is preferably a temperature of a glass transition point or less.

Next, a fuel cell having the membrane electrode assembly is described.

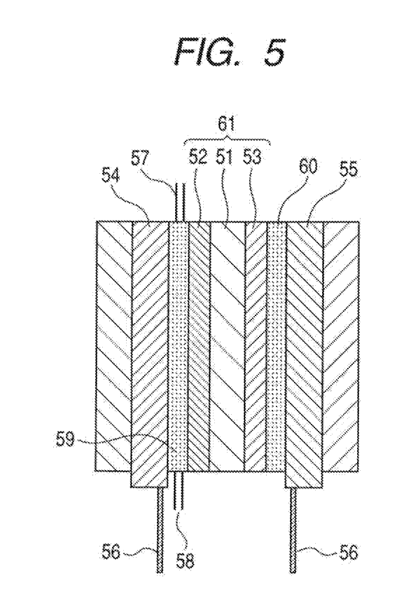

FIG. 5 illustrates an example of a fuel cell unit forming a fuel cell. The fuel cell unit illustrated in FIG. 5 includes: a membrane electrode assembly 61 including a polymer electrolyte membrane 51, an anode catalyst layer 52, and a cathode catalyst layer 53; an anode side diffusion layer 59 being in contact with the anode catalyst layer 52; and a cathode side diffusion layer 60 being in contact with the cathode catalyst layer 53. The fuel cell unit further includes: an anode side current collector 54 being in contact with the anode side diffusion layer 59; a cathode side current collector 55 being in contact with the cathode side diffusion layer 60; an external output terminal 56; a fuel introduction line 57; and a fuel discharge line 58.

The anode side diffusion layer 59 and the cathode side diffusion layer 60 each have a function of diffusing an anode side fuel or a cathode side fuel. As such a diffusion layer, it is preferable to employ a conductive member having a high porosity, and a carbon fiber fabric, carbon paper, and the like may be suitably used. Incidentally, the anode side diffusion layer 59 and the cathode side diffusion layer 60 may be composed of a plurality of layers. Furthermore, in the case where the cathode side diffusion layer is composed of a plurality of layers, of the plurality of layers, a layer to be in contact with the cathode side current collector may be allowed to serve as an oxygen supply layer. An example of a material constituting such an oxygen supply layer is a metal foam.

The anode side current collector 54 and the cathode side current collector 55 each have a function of collecting generated current. As materials of such current collectors, there can be employed metal materials such as SUS or titanium, carbon, and the like.

Incidentally, the fuel cell in accordance with the present invention may have a structure including only a single fuel cell unit as described above, or may have a structure having a plurality of such fuel cell units stacked upon each other.

Furthermore, in the present invention, a fuel, which is generally used for a polymer electrolyte fuel cell, may be used as a fuel, and an oxidizer may be used. Of those, from a practical viewpoint, hydrogen or methanol is preferably used on the anode side, and air is preferably used on the cathode side.

### EXAMPLES

Hereinafter, the present invention is illustrated in greater detail below with reference to the following Examples, but the invention should not be construed as being limited thereto.

### Example 1

In Example 1, a first catalyst precursor layer including platinum and cobalt and having a dendritic shape was formed. Then, a polymer electrolyte was applied thereto. The first catalyst precursor layer was reduced to obtain a second catalyst precursor layer. The second catalyst precursor layer was immersed in a solution containing a platinum salt dissolved therein, and the metal other than platinum existing in a surface portion of the second catalyst precursor layer was substituted with platinum to obtain a catalyst layer. Furthermore, the obtained catalyst layer was used to produce a membrane electrode assembly and a fuel cell unit.

Hereinafter, a specific production method is described.

A first catalyst precursor layer including platinum and cobalt and having a dendritic shape was produced on a sheet. As the production method, a PTFE sheet was placed in a sputter chamber, and the inside of the sputter chamber was evacuated to a pressure of 1.0×10⁻⁴ Pa. Then, Ar and O₂ were introduced at 15 sccm and 85 sccm, respectively, and the total pressure was adjusted to 5.0 Pa with an orifice. Reactive sputtering was conducted at an applied RF power of 12 W/cm² for platinum and an applied RF power of 15 W/cm² for cobalt, to thereby form a first catalyst precursor layer including platinum-cobalt oxide and having a dendritic shape in a thickness of about 2,000 nm on the sheet.

Next, to the first catalyst precursor layer having the dendritic shape and formed on the sheet, a Nafion solution having a concentration adjusted with isopropyl alcohol was dropped, followed by drying.

Next, the sheet having on its surface the first catalyst precursor layer having the Nafion solution dropped thereto and dried was exposed to 2% H₂/He for 10 min to effect reduction of the platinum-cobalt oxide contained in the first catalyst precursor layer, to thereby obtain a second catalyst precursor layer.

Next, about 20 mL of a solution containing 10 mmol/L of potassium hexachloroplatinate (IV) dissolved therein was prepared. The PTFE sheet having the second catalyst precursor layer formed thereon was cut into a desired size and immersed in this solution. Cobalt that exists in the surface portion of the second catalyst precursor layer was substituted with platinum, to thereby obtain a catalyst layer having a dendritic shape. Furthermore, the PTFE sheet provided with the catalyst layer having the dendritic shape was washed with water and dried.

The compositional ratio of platinum to cobalt in the catalyst layer was measured through ESCA and EDX. As a result, the compositional ratio of Pt to cobalt in the catalyst layer measured through EDX was 86 atomic % : 14 atomic %. Meanwhile, the compositional ratio of Pt to cobalt in the catalyst layer measured through ESCA was 92 atomic % : 8 atomic %.

It was seen from the results that the platinum compositional ratio in the surface of the catalyst layer was higher than the platinum compositional ratio of the entire catalyst layer. That is, it was seen that the platinum compositional ratio in the surface of the catalyst structure was higher than the platinum compositional ratio of the entire catalyst structure.

Furthermore, the catalyst layer obtained was transferred on each side of a Nafion film through hot pressing, to thereby produce a membrane electrode assembly. This membrane electrode assembly was built in as illustrated in FIG. 5, to thereby obtain a fuel cell unit.

### Comparative Example 1

In Comparative Example 1, a catalyst layer, a membrane electrode assembly, and a fuel cell unit were produced by following the same procedure as in Example 1 with the exception that the first catalyst precursor layer having a thickness of about 2,000 nm was formed by sputtering only platinum instead of platinum and cobalt used in Example 1, and the second catalyst precursor layer was not immersed in the solution containing 10 mmol/L of potassium hexachloroplatinate (IV) dissolved therein.

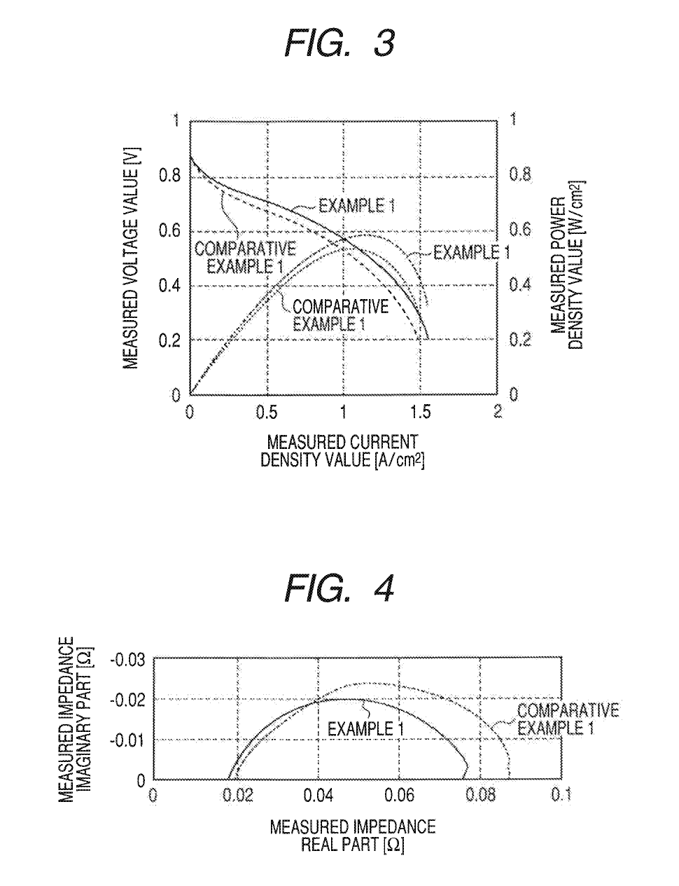

The current-voltage characteristics of the fuel cell units obtained in Example 1 and Comparative Example 1 were evaluated. The used cell was an FC05-01SP cell (trade name; manufactured by ELECTROCHEM, INC.) and a graphite plate was used as a current collector. Furthermore, an LT-1400-W (trade name; manufactured by E-TIC) was used as a gas diffusion layer. Incidentally, the cell unit temperature was set to 80° C., hydrogen humidified to 100% was used on the anode side, and air humidified in the same manner was used on the cathode side. Hydrogen and air were supplied at 500 mL/min and 2,000 mL/min, respectively, to operate the produced cell unit. FIG. 3 illustrates the measured results. The potential difference of the fuel cell unit produced in Example 1 and the fuel cell unit produced in Comparative Example 1 at 400 mA/cm² was 20 mV, and the performance of the fuel cell unit of Example 1 was higher than the performance of the fuel cell unit of Comparative Example 1. Furthermore, the impedances of the fuel cell units of Example 1 and Comparative Example 1 was measured. The conditions included an applied current of 400 mA/cm² and a current amplitude of 20 mA/cm², and the frequency was gradually decreased to a low frequency side from 100 kHz to 0.1 Hz. FIG. 4 illustrates a Cole-Cole plot (complex plane display) of a reactance component 1/(2nfc) resulting from a capacitor component obtained.

It was confirmed as shown in FIG. 4 that the catalyst layer contained in the fuel cell unit of Example 1 has a lower activation resistance than that of the catalyst layer contained in the fuel cell unit of Comparative Example 1, and that the catalytic activity of the catalyst layer contained in the fuel cell unit of Example 1 was higher than the catalytic activity of the catalyst layer contained in the fuel cell unit of Comparative Example 1.

### Example 2

In Example 2, a first catalyst precursor layer including platinum and cobalt and having a dendritic shape was formed, and the first catalyst precursor layer was reduced to obtain a second catalyst precursor layer. The second catalyst precursor layer was immersed in a solution containing a platinum salt dissolved therein, and the metal other than platinum existing in a surface of the second catalyst precursor layer was substituted with platinum. A polymer electrolyte was applied thereto, to thereby obtain a catalyst layer. Furthermore, the obtained catalyst layer was used to produce a membrane electrode assembly and a fuel cell unit.

First, the first catalyst precursor layer including platinum and cobalt and having a dendritic shape was formed on a PTFE sheet in a thickness of about 2,000 nm by following the same procedure as in Example 1.

Next, the sheet having the first catalyst precursor layer including platinum-cobalt oxide and having the dendritic shape was exposed to 2% H₂/He for 10 min to effect reduction of platinum-cobalt oxide in the first catalyst precursor layer, to thereby obtain the second catalyst precursor layer.

Then, about 20 mL of a solution containing 10 mmol/L of potassium hexachloroplatinate (IV) dissolved therein was prepared. The PTFE sheet having the second catalyst precursor layer formed thereon was cut into a desired size and immersed in this solution. Cobalt that exists in the surface of the second catalyst precursor layer was substituted with platinum, to thereby obtain a catalyst structure having the dendritic shape. Furthermore, the PTFE sheet provided with the catalyst structure having the dendritic shape was washed with water and dried.

Next, to the first catalyst precursor layer having the dendritic shape and formed on the sheet, a Nafion solution having a concentration adjusted with isopropyl alcohol was dropped, followed by drying.

The compositional ratio of platinum to cobalt in the catalyst layer was measured through ESCA and EDX. As a result, the compositional ratio of Pt to cobalt in the catalyst layer measured through EDX was 86 atomic % : 14 atomic %. Meanwhile, the compositional ratio of Pt to cobalt in the catalyst layer measured through ESCA was 93 atomic % : 7 atomic %.

It was seen from the results that the platinum compositional ratio in the surface portion of the catalyst layer was higher than the platinum compositional ratio of the entire catalyst layer. That is, it was seen that the platinum compositional ratio at the surface of the catalyst structure was higher than the platinum compositional ratio of the entire catalyst structure.

Furthermore, the catalyst layer obtained was transferred on each side of a Nafion film through hot pressing, to thereby produce a membrane electrode assembly. This membrane electrode assembly was built in as illustrated in FIG. 5, to thereby obtain a fuel cell unit.

### Comparative Example 2

In Comparative Example 2, a catalyst layer, a membrane electrode assembly, and a fuel cell unit were produced by following the same procedure as in Example 2 with the exception that the first catalyst precursor layer having a thickness of about 2,000 nm was formed by sputtering only platinum instead of platinum and cobalt used in Example 2, and the second catalyst precursor layer was not immersed in the solution containing 10 mmol/L of potassium hexachloroplatinate (IV) dissolved therein.

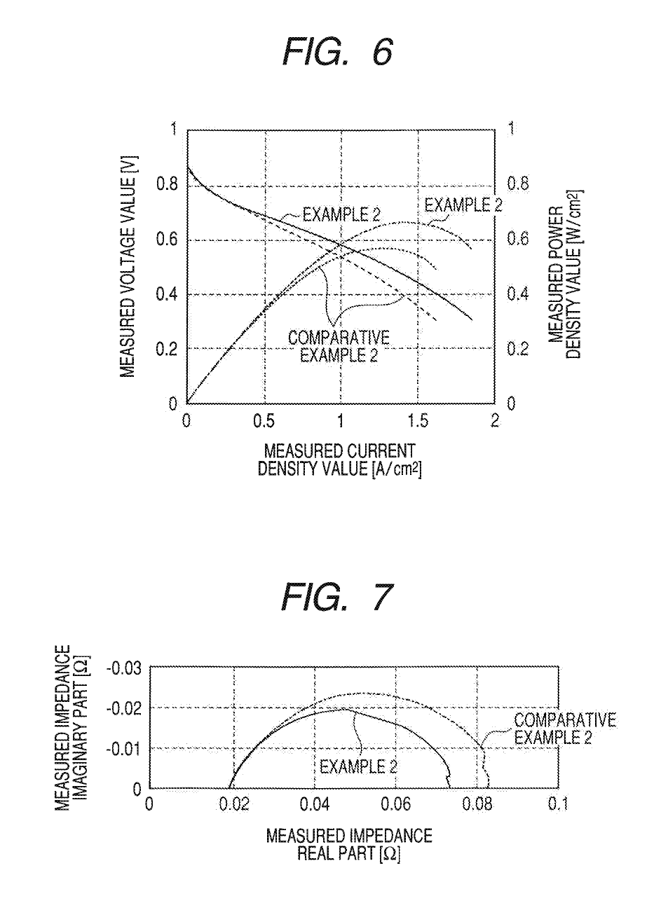

Next, the current-voltage characteristics of the fuel cell units of Example 2 and Comparative Example 2 were evaluated under the same conditions as those of Example 1. FIG. 6 illustrates the measured results. The potential difference of the fuel cell unit produced in Example 2 and the fuel cell unit produced in Comparative Example 2 at 400 mA/cm² was 10 mV, and the performance of the fuel cell unit of Example 2 was higher than the performance of the fuel cell unit of Comparative Example 2. Furthermore, a reduction in activation resistance was confirmed as in Example 1. Moreover, when the same membrane electrode assembly was used repeatedly, the performance of the fuel cell unit of Example 2 was not lowered down to the performance of the fuel cell unit of Comparative Example 2.

Furthermore, it was seen as shown in FIG. 7 that the catalyst layer contained in the fuel cell unit of Example 2 had a lower activation resistance than that of the catalyst layer contained in the fuel cell unit of Comparative Example 2. The results revealed that the catalytic activity of the catalyst layer contained in the fuel cell unit of Example 2 is higher than the catalytic activity of the catalyst layer contained in the fuel cell unit of Comparative Example 2.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-318481, filed Dec. 10, 2007, which is hereby incorporated by reference in its entirety.

1. A catalyst layer comprising:
a polymer electrolyte; and
a catalyst structure having a dendritic shape,
wherein the catalyst structure having the dendritic shape comprises platinum and a metal other than platinum, and
wherein a platinum compositional ratio of a surface of the catalyst structure having the dendritic shape is higher than a platinum compositional ratio of a whole of the catalyst structure having the dendritic shape.

2. The catalyst layer according to claim 1, wherein the metal other than platinum is cobalt.

3. A membrane electrode assembly comprising the catalyst layer according to claim 1.

4. A fuel cell comprising the catalyst layer according to claim 1.

5. A method of producing a catalyst layer, comprising:
forming a first catalyst precursor layer comprising platinum, a metal other than platinum and oxygen and having a dendritic shape;
reducing the first catalyst precursor layer to obtain a second catalyst precursor layer;
substituting at least a part of the metal other than platinum existing in a surface of the second catalyst precursor layer with platinum to obtain a layer including a catalyst structure; and
applying a polymer electrolyte to a surface of the catalyst structure to obtain a catalyst layer.

6. A method of producing a catalyst layer comprising:
forming a first catalyst precursor layer comprising platinum, a metal other than platinum, and oxygen and having a dendritic shape;
applying a polymer electrolyte to a surface of the first catalyst precursor layer;
reducing the first catalyst precursor layer to obtain a second catalyst precursor layer; and
substituting at least a part of the metal other than platinum existing in a surface of the second catalyst precursor layer with platinum to obtain a catalyst layer.
